(19) United States
(12) Patent Application Publication
(10) Pub. No.: US 2013/0025641 A1
(43) Pub. Date: Jan. 31, 2013

(54) WALKER

(71) Applicant: Stuart Miles Goldman, Baltimore, MD (US)

(72) Inventor: Stuart Miles Goldman, Baltimore, MD (US)

(21) Appl. No.: 13/560,886

(22) Filed: Jul. 27, 2012

Related U.S. Application Data
(60) Provisional application No. 61/513,159, filed on Jul. 29, 2011.

(51) Int. Cl. A61H 3/00; B25G 1/06; B62B 3/00

(52) U.S. Cl. 135/67; 280/47.34

(57) ABSTRACT

Briefly, embodiments of methods or apparatuses used in conjunction with a walker are described.

### BACKGROUND

1. Field

This disclosure relates to walking aids, such as walkers, that may be used by the infirmed, the elderly, or other individuals who might benefit from support, proper body positioning, balance, or any other assistance that may be provided by an external support device.

2. Information

If an individual is beset by a mobility-reducing injury, illness, or medical or physiologic status, the individual may make use of a walker or other type of mobility aid. Use of a mobility aid may allow an individual to remain active and/or maintain some amount of independence while convalescing, for example. In some instances, despite attempts to carry on with his or her lifestyle, some individuals may find limitations to activity; mobility aids may potentially provide enhancement of some activities, such as walking, for example.

### BRIEF DESCRIPTION OF DRAWINGS

Claimed subject matter is particularly pointed out and/or distinctly claimed in the concluding portion of the specification. However, both as to organization and/or method of operation, together with objects, features, and/or advantages thereof, claimed subject matter may be understood by reference to the following detailed description if read with the accompanying drawings in which:

FIG. 1 is a perspective view of an individual using an embodiment of a walker;

FIG. 2 is a side view of an individual using the embodiment of FIG. 1;

FIG. 3 is another side view of an individual using the embodiment of FIG. 1;

FIG. 4 is yet another side view of the embodiment of FIG. 1;

FIG. 5 is a view of a portion of a walker according to another embodiment;

FIG. 6 is a side view of two of the pieces that comprise the portion of the walker as viewed in FIG. 5;

FIG. 7 is a view of a portion of a walker according to yet another embodiment;

FIG. 8 is a side view of the portion of FIG. 7;

FIG. 9 is a view of a portion of a walker according to still another embodiment;

FIG. 10 is a view of the portion of FIG. 9;

FIG. 11 is a side view of a shopping cart according to still another embodiment;

FIG. 12 is a side view of a shopping cart with a detachable multi-handled assembly according to still another embodiment; and

FIG. 13 is a rear view of the detachable multi-handled assembly of FIG. 12.

Reference is made in the following detailed description to accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter. It should also be noted that directions and/or references, for example, up, down, top, bottom, left, right, and so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

Reference throughout this specification to “one example,” “one feature,” “one embodiment,” “an example,” “a feature,” “an implementation,” or “an embodiment” means that a particular feature, structure, or characteristic described in connection with the feature, example, or embodiment is included in at least one feature, example, or embodiment of claimed subject matter. Thus, appearances of the phrase “in one example,” “an example,” “in one implementation,” “an implementation,” “an embodiment,” or “in one embodiment” in various places throughout this specification are not necessarily all referring to the same feature, example, or embodiment. Particular features, structures, or characteristics may be combined in one or more examples, features, or embodiments. The term “user” and “individual” may be used interchangeably herein. The term “spinal stenosis,” as used herein, may include any known and/or suspected condition involving the lumbosacral spine, or one or more adjacent structures, in which changing lumbosacral flexion and/or extension may affect local or spinal nerve compression and/or related symptoms.

If an individual is affected by certain conditions that may restrict mobility, an individual may make use of a rolling walking aid, such as a device referred to here as a walker. In this context, the term walker refers to a device that employs wheels to roll while an individual is able to hold the device by a set of handles to walk or stand better and/or with less discomfort as a result of use of the device, in comparison with walking or standing without use of the device. Examples of a walker, without limit, may include the following: standard folding walker comprising rubber tips on the bottom, standard folding walker with wheels in front and slides in back, rollator walker with wheels, such as a three wheeled rollator walker, four-wheeled rollator walker with or without a drop down seat, pediatric walker modifiable to be at a different heights, a bariatric walker designed to accommodate stress of an overweight individual, wheel chairs that have been modified to have handles at the rear that may be adjustable to mimic an adjustable walker, forearm support walker, knee walker, multi-handled shopping cart, and/or walkers that have a host of other not specified modifications to help with varied physical challenges, such as those available from a variety of manufacturers including, for example, Drive Medical Design and Manufacturing, Medline Industries, Inc. (also known as Medical Depot, Inc.), Invacare Corporation, etc.

For many individuals, use of a walker, especially if used over relatively flat terrain, may allow an individual to engage in various activities despite having one or more of a variety of ailments that may affect mobility. Thus, an individual may, for example, engage in walking, shopping, gardening, and so forth. For example, during use of a walker for upright walking, an individual may roughly maintain his or her lower back at an angle referenced to a vertical direction so that discomfort is reduced relative to another angle that may occur, for example, without use of a properly set walker, such as a walker set to an inappropriate height or in unaided walking, or without use of another type of walking aid other than a walker, for example. This may allow an individual to potentially experience at least some independence, which may, for example, be of benefit to an individual's self-esteem, confidence, and/or overall well-being. For example, for those individuals whose mobility may be impaired by disorders of the lumbar spine, including spinal stenosis and/or related conditions, as well as hydrocephalus, multiple sclerosis, Parkinson's, arthritis, and/or a myriad of other neurologic, orthopedic, rheumatologic, and/or other conditions in which maintaining and/or achieving lumbar and/or body position could be helpful, individuals may find at least some relief through the use of a walker. For example, use of a walker may enable an individual to walk with security and/or stability in an at least partially comfortable position along a flat surface. A walker may also allow an individual to maintain a body position that produces less discomfort, as previously mentioned, and thus may enable the individual to walk from place to place potentially experiencing less soreness or pain. See, for example, “Neurogenic Positional Pedal Neuritis,” by Stuart M. Goldman, published in Journal of the American Podiatric Medical Association, May/June 2003, Vol. 93, No. 3.

However, although a walker may provide some relief to individuals walking over flat surfaces, traversing over sloping terrain, such as inclining or declining terrain, may in at least some situations result in additional discomfort. For example, if traversing an incline (e.g., inclining terrain), such as walking up a hill, ramp, or other upwardly sloping surface, in which at least a portion of a walker may be elevated relative to the user, this may result in an individual, while using a walker, positioning, or having the position of the back induced to maintain a different angle referenced to a vertical direction than if the individual is traversing a relatively flat surface, potentially producing additional discomfort. Similarly, if traversing a declining surface (e.g., declining terrain), such as walking down a hill, ramp, or other downward sloping surface, in which at least a portion of a walker may be lowered relative to the user, he or she may, also, in this circumstance, for at least some individuals, maintain the lower back at different angle than if the user is traversing a relatively flat surface, again, potentially producing additional discomfort. Under these circumstances, an individual may even experience distress brought about by positioning the lower back at an angle which may induce greater lumbosacral flexion while walking downhill or greater lumbar extension while walking uphill, resulting in greater discomfort, for example.

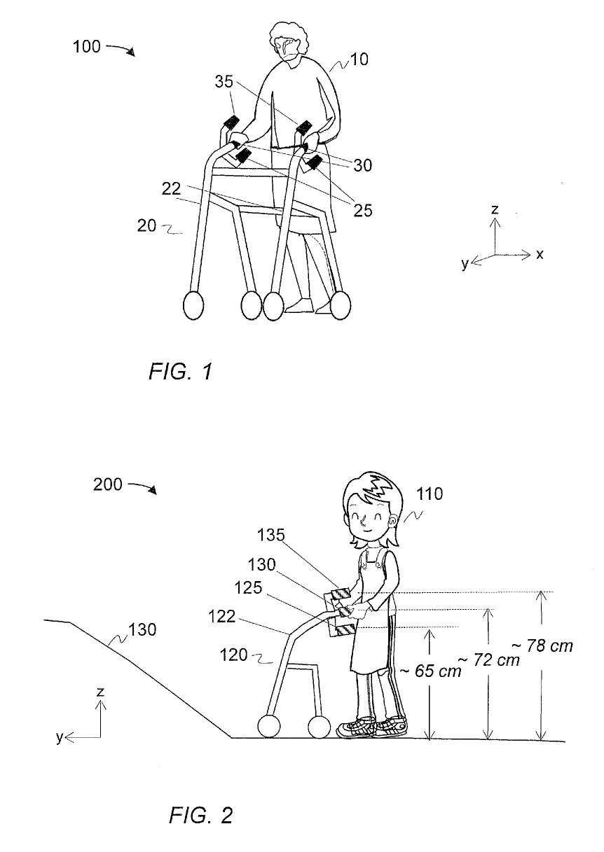

Although state-of-the-art walkers do not address this issue, modification of an existing walker or manufacture of a walker to address sloping terrain, for example, is possible. For example, without limitation, in one illustrative embodiment, a walker may include multiple (such as three or more) handle heights concurrently, as illustrated, for example, in FIG. 1. Multiple handles having varying heights available concurrently, for example, may permit an individual to shift hand position during use. As a result, spine position may also shift such as if traversing terrain having a slope, such as an inclining or declining slope, for example. Thus, handles may be positioned so as to affect angle of the lower back relative to a vertical. An angle may therefore roughly be maintained if traversing inclining or declining terrain, for example, so that potentially less discomfort is experienced. Availability of handles of varying heights concurrently also permits easy adjustment of hand position or shifting of hand position (e.g., switching hands to other pre-positioned handles) without completely removing hands from both handles during use, thus maintaining at least partial control of the walker.

For individuals with spinal stenosis, for example, at least some relief from discomfort may occur by maintaining a particular lower back position while holding on to the handles of the walker, such as, maintaining the lower back at an angle that at least roughly accords with an angle relative to vertical that corresponds to slight and/or at least partially comfortable lumbosacral flexion (See, for example, “Neurogenic Positional Pedal Neuritis,” by Stuart M. Goldman, published in Journal of the American Podiatric Medical Association, May/June 2003, Vol. 93, No. 3.) This may, for example, be determined by an Individual, with or without assistance from a medical professional, or caregiver, or durable medical equipment supplier, in setting a walker handle height. Appropriate height of walker handles for an individual may be influenced by variety of factors, such as height of the individual, relative proportion of height of the legs to the overall height of the individual, length of the arms, amount of lumbosacral flexion to induce adequate opening of the central canal and/or lateral foramen and/or other factors. Furthermore, although an embodiment is shown and described later in which handle height is capable of adjustment, it is, of course, understood that claimed subject matter is not limited in scope to a particular approach or mechanism for accomplishing handle height adjustment. Nonetheless, the embodiment described above, for example, and other embodiments described below, for example, may allow use on flat terrain as well as terrain that may include uphill or downhill angulation for individuals afflicted with spinal stenosis and/or other condition in which a specific lumbosacral position has potential benefit, or in which a person's balance or feeling of security may potentially be helped by the availability of a variety of handle heights on a walker. A modification of an existing walker, for example, or manufacture of a walker including the feature previously described, for example, may allow more comfortable and/or successful hill walking for individuals with symptomatic spinal stenosis, as well as other medical conditions, whose balance or feeling of security could potentially be helped by an availability or a variety of handle heights on a walker.

A recommended position for use of a walker according to standard physical therapy or physiatry recommendations includes bending the arms at approximately 15°-30° while standing in an erect position. See, for example, among other sources, the following: http://www.airsystemsmedical.com/walkerheight.html, http://www.phc-online.com/Measure_for_Rollator_s/8791.htm, http://www.caringtoday.com/deal-with/walker-basics. However, inducing lumbosacral flexion in patients with spinal stenosis and/or related disorders may provide potential benefits in terms of at least partial relief from discomfort. Some individuals with spinal stenosis and/or related disorders may thus potentially benefit from using a walker whose handles are set at a specific height that may, for example, potentially induce a lumbosacral flexion position while the individual's arms are held straight. Arms should be straight while a person is in appropriate lumbosacral flexion since flexing the arms and/or shoulders while in a flexion position may result in tiredness in the arms and/or shoulders that may limit activity, and/or may induce shortness of breath, for example.

For spinal stenosis, a handle height between approximately 88.9 cm (e.g. approximately 35.0 inches) and approximately 66.0 cm (approximately 26.0 inches) off the ground may potentially provide at least some relief from discomfort for at least some individuals between approximately 145 cm tall (e.g., approximately 4′9″) and approximately 196 cm tall (e.g., approximately 6′5″) by potentially inducing an at least partially comfortable flexion position, if set appropriately. However, individuals with spinal stenosis using a walker to improve gait may report an inability to walk comfortably on hills, whether going uphill or downhill. At least one reason for this is that the walker handle(s) become(s) several centimeters higher or lower than previously positioned, in relationship to the position of the individual over flat terrain. If going up a hill, the walker handle height will be higher. If going down a hill, it will be lower. Thus, a desired amount of lumbosacral flexion may no longer be induced. As alluded to previously, if going up a hill, to obtain that position, a person may flex arms and/or shoulders, which may induce discomfort and/or potentially result in cardiovascular strain. In other instances, if going uphill, a person may not substantially change arm and/or shoulder positions, thus potentially eliminating or at least potentially reducing benefit of a lumbosacral position, also potentially resulting in spinal or lower extremity symptoms, which may include discomfort.

Likewise, if going down a hill, walker handle height may be lower than it would be over flat surface, in relation to the position of the individual. To hold onto the walker may therefore induce greater lumbosacral flexion, and may thus induce discomfort, such as back pain or increased lower-extremity neurogenic symptoms, for example. Likewise, an unstable feeling with walking may also occur, such as a feeling of chasing after a walker, which is falling away, in effect.

Standard walkers are typically not constructed in a manner to permit changes in handle height easily. For example, typically removal of a bolt may be involved to change handle height. Even walkers that permit changing height of the handles without removing a bolt may present a challenge. Typically, to change handle height still involves letting go and reaching down to a mechanism on the body of the walker, which may be up to approximately 8.0 inches (approximately 20.3 cm) inches below the handle. Reaching down may involve extensive bending of the back, which may produce discomfort, and may adversely affect stability. Further, even if the adjustment can be made less cumbersome and/or easier to accomplish, for example by way of a rapid adjustment mechanism on a handle of the walker, accuracy of choosing a proper position, or restoring a potentially beneficial position, might be a challenge for at least some and perhaps many elderly persons.

In one example embodiment or implementation, a walker may include handles positioned so as to, during use by an individual to traverse terrain having a slope, roughly maintain an angle of the back of the individual to provide at least partial relief for spinal stenosis in comparison with the angle of the back during use by the individual to traverse terrain that is relatively flat. As shall become clear, a variety of approaches to retrofit an existing walker or to produce a walker in accordance with claimed subject matter are possible. Therefore, it is not intended that claimed subject matter be limited in scope to only the illustrative examples provided herein.

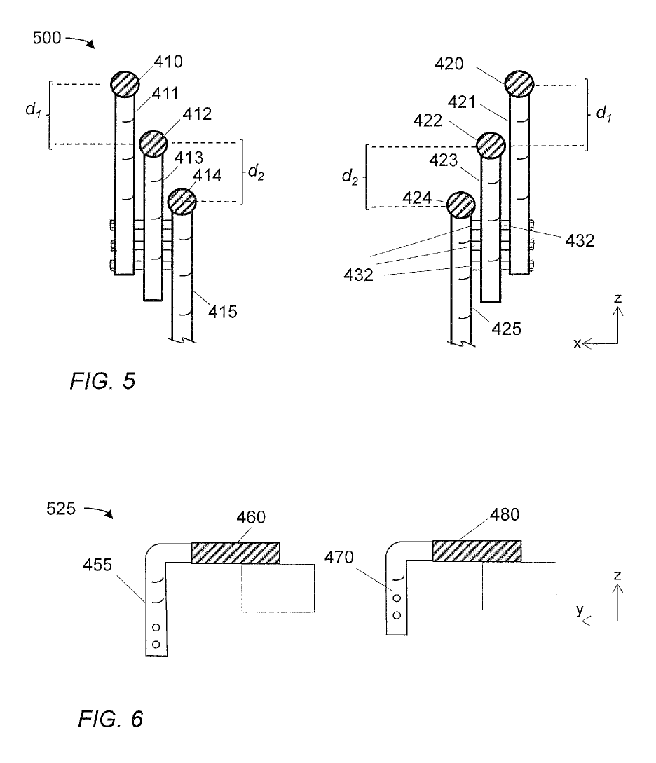

For example, in one embodiment, an attachment for respective sides of a walker may have two handles in addition to the handle present on an existing walker, for example, but might also have four additional handles, for cases of extreme terrain angulation, for example Two additional handles may provide two additional heights, one being 4.0 cm lower than the current therapeutic handle height (also referred to for this embodiment as a standard or flat terrain handle height) for a flat surface, and one being 4.0 cm higher than the handle height which therapeutic for flat surface than the current therapeutic handle height for a flat surface. Thus, in use, without mechanical adjustment, an individual may alter hand position while going up or down hills. For example, a handle and pole may be used to retrofit existing walkers. Continuing with this example, in an illustrative embodiment, a top handle may, for example, be positioned 4.0 cm laterally from a standard, in this example, center, handle. Lateral placement may be employed so that, for this example embodiment, a top handle does not necessarily block access to a standard, in this example, center, handle. Likewise, in an illustrative embodiment, a bottom handle may be positioned 4.0 cm laterally, but the handle itself may extend 12.0 cm further (back) to allow access, without being blocked by a standard height handle. In this example embodiment, additional handles are not placed medially since doing so may potentially interfere with an ability to sit on a walker, an advantage of a walker with drop down seat. However, claimed subject matter is, of course, not limited in scope to an embodiment provided as illustrative, such as this example. Thus, FIGS. 5 to 9 illustrate various embodiments or implementations that include some of these example features, as discussed in more detail below.

According to another example implementation, a walker may comprise at least two poles separated in a lateral direction by approximately a shoulder width of an individual, such as poles 22 illustrated in FIG. 1. Although not explicitly shown in FIG. 1 for convenience, the embodiment of FIG. 1, for example, is intended to be capable of height adjustment, as alluded to previously and described in more detail later. Likewise, although embodiments are provided as illustrative examples, claimed subject matter is not intended to be limited to a particular mechanism or approach for accomplishing handle height adjustment. Varieties of approaches are possible and intended to be included within claimed subject matter. Continuing with an example implementation, however, a walker may comprise at least two handles fastened to a first pole and at least two additional handles fastened to a second pole. The at least two handles may be separated by a vertical distance of between approximately 5.0 and approximately 9.5 centimeters so as to accommodate, for example, a user traversing an inclining or a declining slope. In another implementation, a walker may comprise a third handle fastened to the first pole and a third handle fastened to the second pole. A walker comprising three sets of handles may allow a user to roughly maintain his or her lower back position at an angle referenced to a vertical direction so to reduce discomfort, such as previously described, for example, if traversing over a relatively flat surface (e.g., terrain), an inclining surface (e.g., upwardly sloping terrain), or a declining surface (e.g., downwardly sloping terrain).

As suggested, for example, in an embodiment, an existing walker may be modified, for example, although claimed subject matter is not limited in scope in this respect. For example, in an embodiment, a method may be employed with a conventional walker, which may include existing handles, one for a left hand and one for a right hand, suitable for traversing over relatively flat terrain. A method may adapt a conventional rolling walker so that it may be suitable for use by individuals traversing inclining and/or declining terrain. For example, a method may include fastening or attaching in any suitable manner first and second additional handles to a first pole of the walker, such as adjacent to or proximate with a first existing handle. A method may also include fastening or attaching in any suitable manner first and second additional handles to a second pole of the walker, for example, adjacent to or proximate with a second existing handle. In an example implementation, for example, a walker may comprise two poles, the poles capable of being adjusted in height, for example, separated in a lateral (e.g. left-to-right) direction, and a plurality of handles fastened to the first of the two poles and a second plurality of handles fastened to the second of the two poles. Handles may, for example, be separated laterally, by a distance approximately equal to shoulder width, as well as separated in elevation. Some approaches for fastening or attaching are described in more detail later; however, these are merely illustrative examples. A variety of approaches are possible and it is intended that claimed subject matter not be limited to a particular approach. Also illustrated later, in an embodiment, a handbrake control may be affixed to at least one of the plurality of handles for use, for example, if traversing declining terrain, although, again, claimed subject matter is not limited in this respect.

FIG. 1 is a perspective view of an individual using an embodiment 100 of a walker. In FIG. 1, user 10 may be seen using a rollator walker, such as 20, perhaps traversing in a+y direction over a relatively flat surface. Again, although not explicitly shown in FIG. 1 for convenience, the embodiment of FIG. 1, for example, is intended to be capable of height adjustment, as alluded to previously and described in more detail later. Likewise, although embodiments are provided as illustrative examples, claimed subject matter is not intended to be limited to a particular mechanism or approach for accomplishing handle height adjustment. Varieties of approaches are possible and intended to be included within claimed subject matter.

Handles 30, which may be fastened to poles 22 or may form a part of poles 22, for example, may include handle grips, which are partially obscured from view by the hands of user 10. At a distance of between approximately 5.0 centimeters (e.g., approximately 2.0 inches) and approximately 10.0 centimeters (e.g., approximately 3.9 inches) above handles 30, handles 35 may be fastened or attached to poles 22, again, in a suitable manner. It is noted that terms, such as coupled, connected, fastened, attached and/or similar terms are used interchangeably with no loss in meaning or understanding in this particular context. An additional pair of handles 25 may be fastened to poles 22 at an elevation lower than handles 30 by approximately 5.0 centimeters to approximately 10.0 centimeters (e.g., approximately 2.0 to approximately 3.9 inches), for example. However, it should be noted that claimed subject matter is not limited in these respects.

FIG. 2 is a side view of an individual using the embodiment of FIG. 1. In FIG. 2, pole 122 may represent two or more poles which may be substantially in accord with, for example, a general structure of rollator walker 20 of FIG. 1. Further, although a single one of handles 125, 130, and 140 is shown, it may be appreciated that, at least in some implementations, handles 125, 130, and 140 may represent handles on alternate sides of a walker, for example.

In FIG. 2, user 110 is shown using handles 130, which may be positioned between upper handles 135 and lower handles 125, while using the walker to traverse a relatively flat surface in a forward (+y) direction. In FIG. 2, middle handles 140 may represent standard height handles of a single-handled walker, such as a rollator walker, comprising left and right handles, for example, attached to respective height adjustable poles 122, as previously explained. In an example implementation, lower handles 125 may be located at approximately 65.0 centimeters (e.g., approximately 25.6 inches) in elevation; however, in other implementations, handles may be positioned at lower elevations, such as approximately 60.0 centimeters (e.g., approximately 23.6 inches), or may be positioned at a greater elevation, such as approximately 70.0 centimeters (e.g., approximately 27.6 inches). In some implementations, positioning lower handles at an elevation of approximately 65.0 centimeters (e.g., approximately 25.6 inches) may enable users as small as approximately 148.0 centimeters (e.g., approximately 4 feet, 10.0 inches) to potentially benefit from positioning of lower handles. However, handles located at approximately 65.0 centimeters (e.g., approximately 25.6 inches) represent merely one of many possible implementations, and claimed subject matter is not limited in this respect.

Handles 130 may be positioned at an elevation of approximately 72.0 centimeters (e.g., approximately 28.3 inches). However, in other implementations, handles 130 may be positioned lower in elevation, such as approximately 60.0 centimeters (e.g., approximately 23.6 inches), or may be positioned at a greater elevation, such as approximately 80.0 centimeters (e.g., approximately 31.5 inches). Handles 135, shown in FIG. 2 as located at a greater elevation than handles 130, may be positioned at an elevation of approximately 78.0 centimeters (e.g., approximately 31.0 inches). However, in other implementations, handles 135 may be located at elevations of, for example, approximately 70.0 centimeters (e.g., approximately 28.0 inches), or, for example, approximately 85.0 centimeters (e.g., approximately 33.5 inches). It should be noted that claimed subject matter is not limited to particular elevations of handles, such as handles 125, 130, and 135, as for taller users handles being located at a greater elevation may be more desirable, whereas for other users of other heights handles positioned at lower elevations may be more desirable.

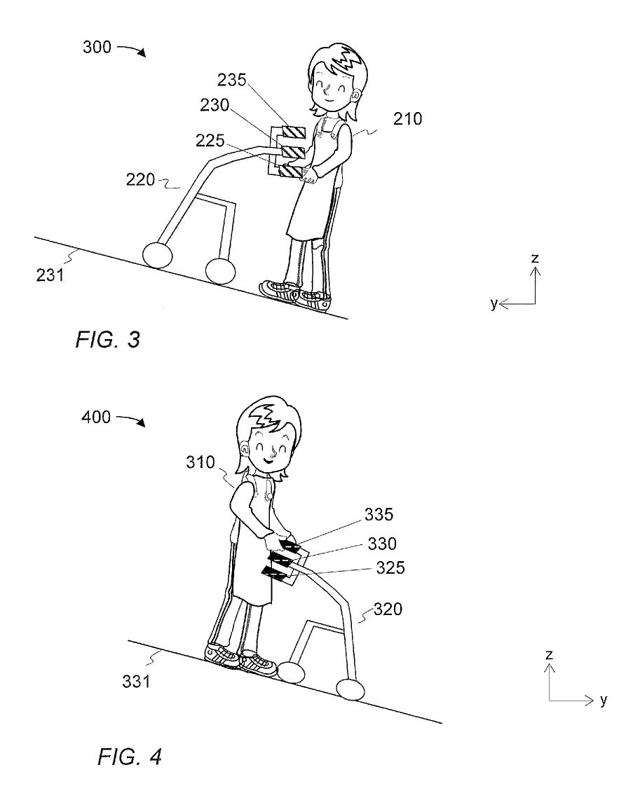

FIG. 3 is another side view of the embodiment of FIG. 1. In FIG. 3, at least a portion of the walker is shown as elevated relative to user 210. Accordingly, as user 210 traverses inclining surface 231, for example, user 210 may make use of handles 225 for support, and handles 230 and 235 may be unused. While maintaining contact with handles 225, the lower back of user 210 may be roughly maintained at an angle referenced to a vertical direction resulting in less discomfort, as previously explained, for example.

FIG. 4 is yet another side view of the embodiment of FIG. 1. In FIG. 4, at least a portion of the walker is shown as lowered relative to user 310. Accordingly, as user 310 traverses declining surface 331, user 310 may make use of handles 335 for support, and handles 325 and 330 may be unused. While maintaining contact with handles 340, the lower back of user 310 may be roughly maintained at an angle referenced to a vertical direction resulting in less discomfort, as previously explained, for example.

FIG. 5 is a view of a portion 500 of another embodiment of a walker. Components of FIG. 5 may correspond to handles, distributed both laterally (±x) and in elevation (±z), of a walker, such as one of the embodiments previously described, for example. In FIG. 5, handle grip pairs 412 and 422 may correspond, for example, to handles 130 of FIG. 2 if viewed from behind the walker. Handle grip pairs 414 and 424 may correspond, for example, to handles 125 of FIG. 2. Handle grip pairs 410 and 420 may correspond, for example, to handles 135 of FIG. 2. Further, nothing prevents the use of additional handles, perhaps differently distributed laterally and/or in elevation, for example. As previously indicated, it is intended that claimed subject matter include a variety of potential variations.

Handle grip 414, for example, may be coupled to pole 415, which may, at least in certain implementations, correspond to a pole or a shaft of a walker that may permit adjustment of handle 414, for example. In an illustrative implementation, handle grip 414 may be coupled or form a part of pole 415, in addition to handle 411 and handle 413. In an illustrative implementation, although not intending to limit claimed subject matter in any way, handles 411 and 413 may be fastened to pole 415, for example, by way of three hexagonal bolts as shown in FIG. 5. Spacers, such as spacers 432 shown at the right-hand portion of FIG. 5, may be used to separate handles 411 and 413 from pole 415 in an illustrative embodiment. Similarly, spacers may be used to separate handles 421 and 423 from pole 425. In an example implementation, spacers 432 may reduce interference of adjacent, unused handle grips. For example, if a user grasps handle grip 422, spacers 432 may reduce the likelihood of one or more of handle grips 420 and/or 424 interfering with a user's hand.

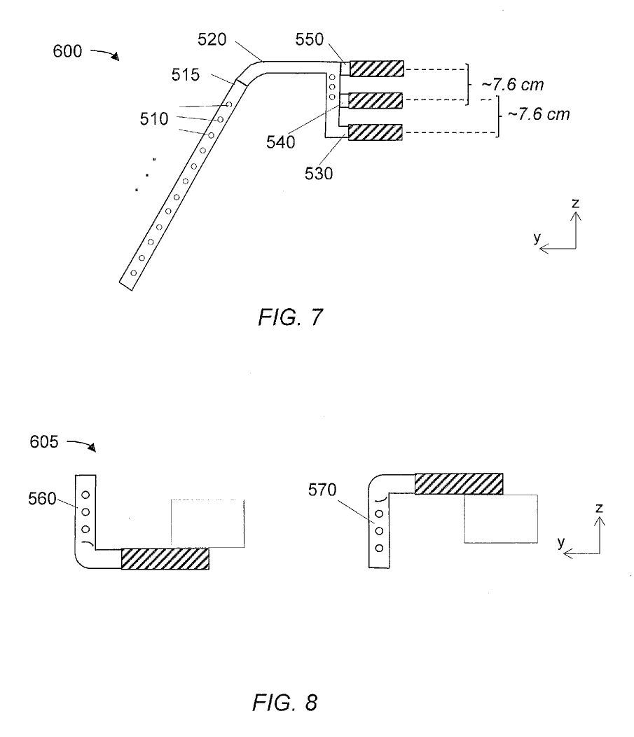

In FIG. 5, handles 411 and 413 are shown as being fastened to the left of pole 415; and handles 421 and 423 are shown to the right of pole 430. However, in an implementation, handles 413 and 423 may be located inside of poles 415 and 425. For example, as previously mentioned, in an embodiment, if a walker comprises a seat which may be fastened to poles 415 and 425, placement of additional handles, and associated handle grips, may provide clearance for a user to be seated. Although poles 415 and 425 are shown as corresponding to poles of a walker that may rise upward from a lower portion of a walker, in other implementations, poles 415 and 425 may comprise other possible shapes or arrangements, such as, for example, arc-shaped in a manner that rises upward from a lower portion of a walker and curves downward in a manner that accords, for example, with a general shape of a shaft, such as shaft 520 of FIG. 7, for example.

Dimensions d₁ and d₂ may indicate differences in elevation between handle grips of an embodiment. In FIG. 5, for example, d₁ and d₂ may correspond to approximately 6.35 to approximately 7.62 centimeters (e.g., approximately 2.5 to approximately 3.0 inches). However, in other implementations, d₁ and d₂ may correspond to, for example, approximately 5.0 centimeters to approximately 10.0 centimeters (e.g., approximately 2.0 inches to approximately 3.9 inches).

FIG. 6 is a side view 525 of a portion shown in FIG. 5. In an implementation, handle 455 and handle grip 460 may correspond to handle 413 coupled to handle grip 412 and/or handle 423 coupled to handle grip 422 of FIG. 5. As can be seen in FIG. 6, handle 455 includes two holes through which hexagonal bolts, for example, may be accommodated. FIG. 6 also shows handle 470 and handle grip 480, which may, for example, correspond to one or more of handle 411 coupled to handle grip 410 and/or handle 421 coupled to handle grip 420 of FIG. 5. It should be noted, however, that although handles 455 and 470 comprise right angled shapes, implementations may include handles of various shapes and angles, such as acute angles, obtuse angles, straight angles, and so forth. Again, a variety of approaches are possible and it is intended that claimed subject matter cover such possible approaches.

FIG. 7 is a view of a portion 600 of yet another embodiment. In FIG. 7, for example, shaft 520 may be inserted into a hollow pole or tube 515. Hollow pole or tube 515 may have twelve holes 510 while shaft 520 may have one or more holes (not shown since shaft 520 is depicted as inserted inside 515) and may fasten to hollow pole or tube 515 by way of one or more bolts or other type of fastener inserted through one or more of holes 510. Thus, holes 510 shown in hollow pole or tube 515 are arranged to align with the one or more holes in shaft 520 so that a consistent, stable, but adjustable handle height is capable of being achieved. In other embodiments, hollow pole or tube 515 may have a different number of holes, such as 10 or fewer, or may have a greater number of holes such as, for example, 15 holes, 20 holes, and so forth. Further, hollow pole or tube 515 may include features that allow adjustment of the length of the hollow pole or tube, such as, for example, permitting a first portion of hollow pole or tube 515 to slide within a second portion of the hollow pole or tube, which may thereby allow an increase or a decrease in the length of the pole or tube, for example.

Handle 530 may form a lower portion of shaft 520 and provide mounting accommodations for handles 540 and 550. As shown in FIG. 7, by positioning a narrow portion of shaft 520 within hollow pole 515, an assembly, which may comprise shaft 520, handles 530, 540, and 550, may be adjusted in height, which may accommodate a variety of users of differing heights in a manner so as to permit walking with reduced discomfort over inclining and/or declining terrain, as previously explained, for example. In the embodiment of FIG. 7, handles 550, 540, and 530 are shown as separated in elevation by approximately 7.6 cm (e.g. approximately 3 inches) although nothing prevents separation in elevation by other amounts. Although not explicitly shown in FIG. 7, embodiments may comprise handle 540 being positioned approximately 2.54 cm (e.g. approximately 1 inch) below a topmost of holes 510.

In still another embodiment, handle height may be adjusted, for example with a spring or similar mechanism. For example, a pole having a handle may fit within or fit outside a tube. There may be through holes in the pole or the tube so that a latch with a spring may be employed to secure a particular height, for example. For example, a handle may be raised or lowered in 1 inch increments and engaged or disengaged via a latch, for example, that may be capable of moving in and out of one of the holes to thereby secure or release a particular handle height. For example, holes may be in a pole attached to the walker and a latch may be engaged or disengaged by pushing a spring-loaded latch integrated into a shaft, as one illustrative example. However, many other adjustment approaches are possible and, again, claimed subject matter is intended to cover a variety of approaches.

Handles 540 and 550 may be added at locations higher in elevation than handle 530, and handle 530 may be located at an elevation lower than a handle height utilized in a walker, such as a rollator walker, for example. In an implementation, addition of handles at lower elevations may, for example, accommodate users who may be shorter in stature, for example. For example, for traversing relatively flat surfaces, a user may grasp a grip associated with handle grip 540. For traversing inclining terrain, a user may grasp a grip associated with handle 530. For traversing declining terrain, a user may grasp a grip associated with handle 550. It should be noted that although FIG. 7 indicates a particular layout of components, nothing prevents different handle arrangement, such as laterally and/or in elevation, for example. Again, claimed subject matter is intended to cover a variety of approaches. Further, although FIG. 7 shows hollow pole 515 comprising 12 holes 512, nothing prevents a greater or lesser number of holes through hollow pole 515 depending on a range of adjustment in height of shaft 520 relative to hollow pole 515. Likewise, as explained previously, claimed subject matter includes other approaches or mechanisms for adjusting handle height.

FIG. 8 is a side view 605 of the portion of an embodiment shown in FIG. 7. In FIG. 8, handle 560 may correspond, for example, to handle 540 of FIG. 7. Handle 570 may correspond, for example, to handle 550 and of FIG. 7. In an embodiment, handles 560 and 570 may be mounted to shaft 520 of FIG. 7 by way of three holes, which may accommodate a corresponding number of fasteners for attaching handles 560 and 570 to shaft 520, shown in FIG. 7, for example.

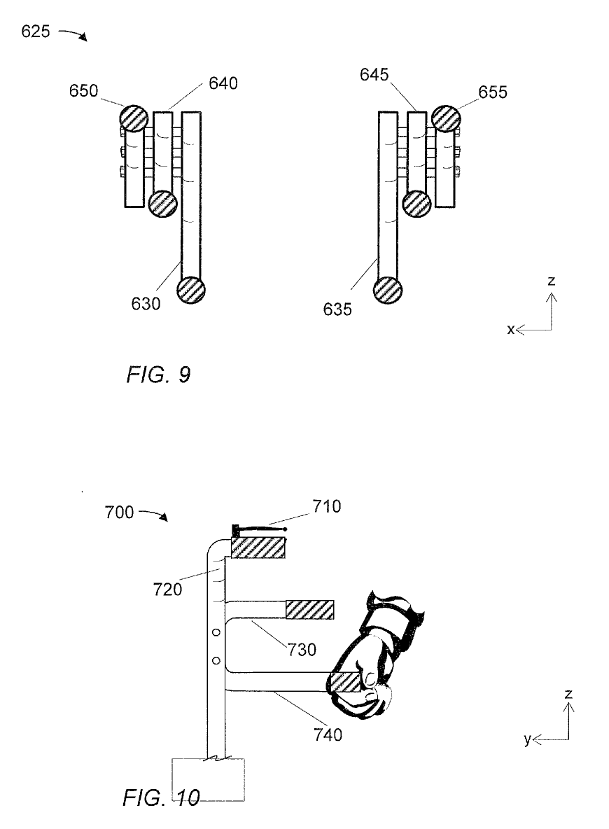

FIG. 9 is a view of a portion 625 of another embodiment of a walker comprising three handles similar to the embodiment of FIG. 7. In FIG. 9, lower handles 630 and 635 may correspond to handle 530 of FIG. 7. Handles 640 at 645 may correspond to handle 540, and upper handles 650 and 655 may correspond to handle 550, which may form a part of shaft 520, as shown in FIG. 7. Of course, varieties of arrangements are possible and are intended to be included within claimed subject matter.

FIG. 10 is a side view 700 of a portion of another embodiment. In FIG. 9, for example, handbrake 710 is shown affixed to handle 720. In an implementation, handbrake 710 may provide a user with an ability to slow forward motion of a walker, for example. Handbrake 710 may be used in association with a disc brake or other device for slowing or stopping rotation of one or more wheels, such as of a rollator walker, for example. FIG. 10 includes handle 730 and 740, which may comprise additional length in a +y direction than handle 720. In an example implementation, additional length may permit a user to make use of handle 740, for example, without significant interference from handle 730, for example. In an implementation, a handle grip of handle 720 may be set forward from a handle grip of handle 730 by approximately 9.0 centimeters to approximately 15.0 centimeters (e.g., approximately 3.5 inches to approximately 6.0 inches). However, in other implementations, for example, handle grips may be set forward relative to one another by different amounts. Further, handbrake 710 may be mounted to handle 730, 740, and/or any previously described handle or elsewhere, such as, for example, one or more handles shown in any of FIGS. 1-9, to assist a user in slowing or stopping rotation of one or more wheels of a rollator walker, for example. Again, claimed subject matter is not limited in scope in these regards.

In other embodiments, one or more handles may be used in which multiple holding position, multiple angular orientations and/or multiple effect heights may result. For example, a handle embodiment may comprise a configuration in which a handle may swivel, may be capable of being locked into multiple angular positions, may retract, may fold or unfold, may slide along a shaft to various points capable of being locked In other embodiments, or a host of other mechanical arrangements that may, in effect, allow positioning of a handle at multiple handle heights for traversing over hilly (e.g., inclining and/or declining) terrain. Further, handles may comprise substantially horizontal bars arranged at multiple elevations corresponding to, for example, substantially multiple horizontal bars arranged on a wheeled shopping cart or shopping basket.

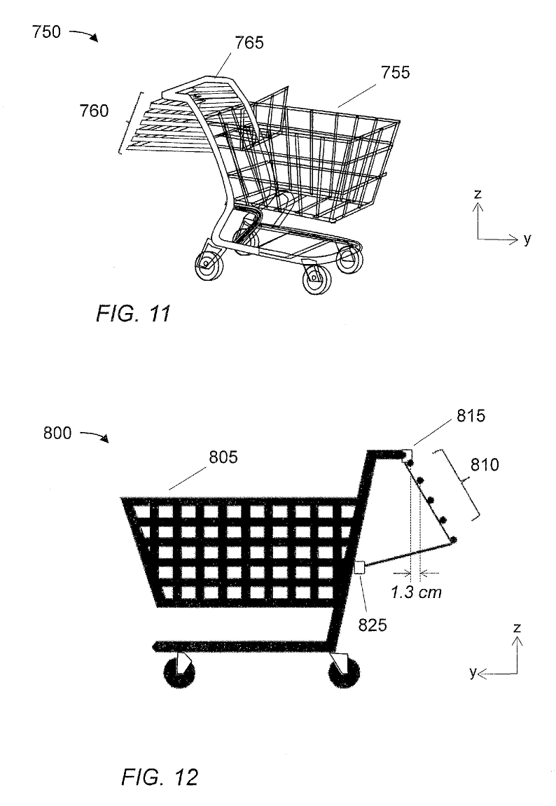

FIG. 11 is a side view of a shopping or gorcery cart according to still another embodiment 750. In FIG. 11, a shopping or grocery cart, such as 755, may be modified to comprise horizontal bars, such as 760, a first of which may be positioned at approximately 6.3 cm (e.g. approximately 2.5 inches) below a top horizontal bar 765. Remaining ones of horizontal bars 760 may be successively positioned at locations along a pole or shaft that may, for example, support top horizontal bar 765. Of course, this is merely one illustrative example. Many other varieties and/or arrangements are possible and are intended to be included within claimed subject matter.

FIG. 12 is a side view of a shopping or grocery cart with a detachable multi-handled assembly according to still another embodiment 800. In FIG. 12, horizontal bars 810 may comprise a multi-handled assembly attached to a shopping or grocery cart, such as 805, using clamps or other fastening devices, such as 815 and/or 825, for example. Horizontal bars 810 may be staggered to permit easy positioning of one or more of a user's hands, for example, at a position along one of the horizontal bars. Horizontal bars 810 may be arranged in a staggered fashion, wherein, for example, bars are positioned, as shown in FIG. 12, at approximately 1.3 cm (e.g., approximately 0.5 inch) increments in relation to an adjacent horizontal bar. Of course, again, many varieties comprising numerous mechanisms for attaching a multi-handled assembly to a shopping cart are intended to be included within claimed subject matter. This is merely an illustrative example.

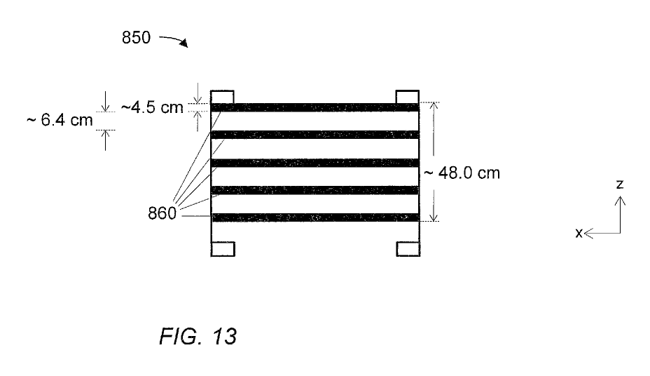

FIG. 13 is a rear view 850 of the detachable multi-handled assembly of FIG. 12. In FIG. 13, horizontal bars 860 are shown as comprising a diameter of approximately 4.5 cm (e.g., approximately 1.75 inches) for example. Spacing between adjacent ones of horizontal bars 860 is shown as comprising approximately 6.4 cm (e.g., approximately 2.5 inches). Horizontal bars 860 may be arranged to span approximately 48.0 cm (e.g., approximately 18.9 inches). It should be noted, however, that claimed subject matter is not limited in these respects, as many variations in a number of horizontal bars, diameter of one or more horizontal bars, spacing between adjacent horizontal bars, and/or other aspects are intended to be included within claimed subject matter.

In accordance with an embodiment, a method of using a walker, such as a rollator walker, is described. For example, an individual may walk with arms sufficiently straight and with walker handle height adjusted to accommodate a walking position with arms sufficiently straight so as to roughly maintain an angle of the back to induce sufficient lumbosacral flexion, which may result in at least partial relief for spinal stenosis and/or related disorders if traversing terrain having a slope, such as in comparison with the angle that would be induced during use to traverse terrain that is relatively flat. Of course, the sloping terrain may include an inclining slope or a declining slope. For an inclining slope, for example, in an illustrative embodiment, an adjusted handle height may comprise the height of a set of handles below a set of handles having a handle height adjusted for relatively flat terrain, such as previously described as a standard handle height, for example. It is noted, as previously described, for example, walking comprises traversing sloping terrain and relatively flat terrain without completely letting go of the walker, providing a potential benefit to a user, for example. Likewise, for a declining slope, adjusted handle height may comprise the height of a set of handles above a set of handles having a handle height adjusted for relatively flat terrain. Again, it is noted, walking may comprise traversing sloping terrain and relatively flat terrain without completely letting go of the walker, providing a potential benefit to a user, for example.

While there has been illustrated and/or described what are presently considered to be example features, it will be understood by those skilled in the relevant art that various other modifications may be made and/or equivalents may be substituted, without departing from claimed subject matter. Additionally, many modifications may be made to adapt a particular situation to teachings of claimed subject matter without departing from the central concept(s) described herein. Therefore, it is intended that claimed subject matter not be limited to particular examples disclosed, but that such claimed subject matter may also include all aspects falling within appended claims and/or equivalents thereof.

1. An apparatus comprising:
a walker including handles positioned so as to roughly maintain an angle of the back of an individual to induce sufficient lumbosacral flexion to reduce discomfort during use by said individual to traverse terrain having a slope in comparison with said angle of the back during use by said individual to traverse terrain that is relatively flat.

2. The apparatus of claim 1, wherein said slope of said terrain comprises an inclining slope.

3. The apparatus of claim 1, wherein said slope of said terrain comprises a declining slope.

4. The apparatus of claim 1, wherein said handles comprise a modification of a pre-existing rollator walker.

5. The apparatus of claim 1, wherein said handles comprise a modification of a pre-existing shopping or grocery cart

6. The apparatus of claim 1, wherein said handles are height adjustable.

7. The apparatus of claim 6, wherein said handles are height adjustable to affect said angle of the back for individuals of varying heights relative to an amount of slope of said terrain.

8. The apparatus of claim 1, wherein said handles comprise a set of handles including handles positioned for relatively flat terrain, handles positioned for terrain declining slope and handles positioned for terrain that has an inclining slope.

9. An apparatus comprising:
a walker including multiple handles positioned at multiple heights so as to roughly maintain an angle of the lumbosacral spinal position of an individual to provide at least partial relief for spinal stenosis during use by said individual to traverse terrain having a slope in comparison with said angle that would be induced if there were one handle height.

10. The apparatus of claim 9, wherein said slope of said terrain comprises an inclining slope.

11. The apparatus of claim 9, wherein said slope of said terrain comprises a declining slope.

12. The apparatus of claim 9, wherein said handles comprise a modification of a pre-existing rollator walker.

13. The apparatus of claim 9, wherein said handles comprise a modification of a pre-existing shopping or grocery cart.

14. The apparatus of claim 9, wherein said handles are height adjustable.

15. The apparatus of claim 14, wherein said handles are height adjustable to affect said angle for individuals of varying heights and/or relative to said amount of slope of said terrain.

16. The apparatus of claim 9, wherein said handles comprise a set of handles including handles positioned for relatively flat terrain, handles positioned for terrain that has a declining slope and handles positioned for terrain that has an inclining slope.

17. An apparatus comprising:
a walker, said walker including at least two poles separated in a lateral direction by approximately shoulder width; at least two handles fastened to a first of said at least two poles; and at least two handles fastened to a second of said at least two poles; said poles being height adjustable.

18. The apparatus of claim 17, wherein said at least two handles fastened to said first of said at least two poles are separated in elevation by between approximately 5.0 and 10.0 centimeters.

19. The apparatus of claim 17, wherein said first of said at least two handles fastened to said first of said at least two poles are separated by between approximately 3.0 and 5.0 centimeters in said lateral direction.

20. The apparatus of claim 17, wherein said at least two handles fastened to said first of said at least two poles are separated by between approximately 9.0 and 15.0 centimeters in a forward direction.

21. The apparatus of claim 17, additionally comprising:
at least a third handle fastened to said first of said two poles, and;
at least a third handle fastened to said second of said two poles.

22. The apparatus of claim 17, wherein said at least two handles and said at least said third handle fastened to said first of said at least two poles are distributed in said lateral direction.

23. The apparatus of claim 17, wherein said at least two handles and said at least said third handle fastened to said first of said at least two poles are distributed in elevation.

24. The apparatus of claim 17, wherein one of said at least two handles and said at least said third handle fastened to said first of said at least two poles is positioned at an elevation of approximately 65.0 centimeters.

25. A method of using a walker comprising:
walking with arms sufficiently straight and handle height adjusted to accommodate a walking position with arms sufficiently straight so as to roughly maintain an angle of the back to induce sufficient lumbosacral flexion to provide at least partial relief for spinal stenosis during use to traverse terrain having a slope in comparison with said angle that would be induced during use to traverse terrain that is relatively flat.

26. The method of claim 25, wherein said slope of said terrain comprises an inclining slope.

27. The method of claim 26, wherein said adjusted handle height comprises the height of a set of handles below a set of handles having a handle height adjusted for relatively flat terrain.

28. The method of claim 27, wherein said walking comprises traversing sloping terrain and relatively flat terrain without completely letting go of the walker.

29. The method of claim 25, wherein said slope of said terrain comprises a declining slope.

30. The method of claim 29, wherein said adjusted handle height comprises the height of a set of handles above a set of handles having a handle height adjusted for relatively flat terrain.

31. The method of claim 30, wherein said walking comprises traversing sloping terrain and relatively flat terrain without completely letting go of the walker.
